(19) United States
(12) Patent Application Publication
(10) Pub. No.: US 2022/0306121 A1
(43) Pub. Date: Sep. 29, 2022

(54) METHOD FOR DETECTING BUMPY REGION OF ROAD SURFACE, ELECTRONIC DEVICE, STORAGE MEDIUM, AND VEHICLE

(71) Applicant: APOLLO INTELLIGENT CONNECTIVITY (BEIJING) TECHNOLOGY CO., LTD., BEIJING (CN)

(72) Inventors: Liang XING, BEIJING (CN); Shuqing SONG, BEIJING (CN); Yi WU, BEIJING (CN); Wentao YANG, BEIJING (CN); Shuaishuai ZHAO, BEIJING (CN); Qionghua LUO, BEIJING (CN); Lifeng WANG, BEIJING (CN); Yunchan FENG, BEIJING (CN); Tao WANG, BEIJING (CN); Xiaochen CAO, BEIJING (CN); Fuchuang WU, BEIJING (CN)

(21) Appl. No.: 17/842,120

(22) Filed: Jun. 16, 2022

(30) Foreign Application Priority Data
Jun. 17, 2021 (CN) 202110671500.8

(51) Int. Cl. B60W 40/06; G06V 20/56

(52) U.S. Cl. CPC B60W 40/06; G06V 20/588; B60W 2420/42; B60W 2552/35

(57) ABSTRACT

A method for detecting a bumpy region of a road surface, an electronic device, a storage medium and a vehicle, are provided, and relate to the field of computer technology. The method includes: acquiring driving state data of a vehicle and an orientation of the vehicle; determining, according to the driving state data, whether the vehicle passes through the bumpy region of the road surface; and in a case where the vehicle passes through the bumpy region of the road surface, determining a location of the bumpy region of the road surface according to the driving state data and the orientation of the vehicle.

### CROSS-REFERENCE TO RELATED APPLICATION

This application claims priority to Chinese patent application No. 202110671500.8, filed on Jun. 17, 2021, which is hereby incorporated by reference in its entirety.

### TECHNICAL FIELD

The present disclosure relates to the field of computer technology, and in particular, to the field of data processing.

### BACKGROUND

Speeds of a vehicle on different road sections may be different in a process of driving on a road surface. In a case where there is a pothole or bulge on the road surface where the vehicle drives, bumps may be caused if the vehicle does not slow down in time, which may affect ride comfort, and even cause a safety accident in severe cases. Therefore, it is necessary to detect a location of the bumpy region of the road surface, to remind other vehicles passing through the road section to slow down or to remind road maintenance personnel to carry out road maintenance in time.

### SUMMARY

The present disclosure provides a method and apparatus for detecting a bumpy region of a road surface, an electronic device, and a storage medium.

According to an aspect of the present disclosure, there is provided a method for detecting a bumpy region of a road surface, including:

acquiring driving state data of a vehicle and an orientation of the vehicle;

determining, according to the driving state data, whether the vehicle passes through the bumpy region of the road surface; and

in a case where the vehicle passes through the bumpy region of the road surface, determining a location of the bumpy region of the road surface according to the driving state data and the orientation of the vehicle.

According to another aspect of the present disclosure, there is provided an electronic device, including:

at least one processor; and

a memory communicatively connected with the at least one processor,

wherein the memory stores instructions executable by the at least one processor, and the instructions, when executed by the at least one processor, enable the at least one processor to perform the method of any one of the embodiments of the present disclosure.

According to another aspect of the present disclosure, there is provided a non-transitory computer-readable storage medium storing computer instructions, wherein the computer instructions, when executed by a computer, cause the computer to perform the method of any one of the embodiments of the present disclosure.

According to another aspect of the present disclosure, there is provided a vehicle including at least one of the apparatus, the electronic device, or the non-transitory computer-readable storage medium of any one of the embodiments of the present disclosure.

It should be understood that the content described in this section is neither intended to limit the key or important features of the embodiments of the present disclosure, nor intended to limit the scope of the present disclosure. Other features of the present disclosure will be readily understood through the following description.

### BRIEF DESCRIPTION OF THE DRAWINGS

The drawings are used to better understand the solution and do not constitute a limitation to the present disclosure. In which:

FIG. 1 is a schematic diagram of a method for detecting a bumpy region of a road surface according to an embodiment of the present disclosure;

FIG. 2 is a schematic diagram where a vehicle detects that the vehicle runs over a pothole according to an embodiment of the present disclosure;

FIG. 3 is a schematic diagram where a pothole is in the field of view of a camera according to an embodiment of the present disclosure;

FIG. 4 is an image of a bumpy region of a road surface according to an embodiment of the present disclosure;

FIG. 5 is a schematic diagram where an orientation of a vehicle is opposite to an orientation of a camera according to an embodiment of the present disclosure;

FIG. 6 is a schematic diagram of a method for detecting a bumpy region of a road surface according to an embodiment of the present disclosure;

FIG. 7 is a schematic diagram of an apparatus for detecting a bumpy region of a road surface according to an embodiment of the present disclosure;

FIG. 8 is a schematic diagram of a second determination module according to an embodiment of the present disclosure; and

FIG. 9 is a block diagram of an electronic device for implementing a method for detecting a bumpy region of a road surface according to an embodiment of the present disclosure.

### DETAILED DESCRIPTION

Exemplary embodiments of the present disclosure are described below in combination with the drawings, including various details of the embodiments of the present disclosure to facilitate understanding, which should be considered as exemplary only. Thus, those of ordinary skill in the art should realize that various changes and modifications can be made to the embodiments described here without departing from the scope and spirit of the present disclosure. Likewise, descriptions of well-known functions and structures are omitted in the following description for clarity and conciseness.

The technical solutions of the present disclosure may be applied to application scenarios such as a human-driven vehicle, an autonomous vehicle and the like. In a case where the vehicle passes through a bumpy region of a road surface, the bumpy region of the road surface may be accurately located by using driving state data and an orientation of the vehicle during a driving process, to remind drivers of other vehicles or autonomous vehicles to slow down or take other measures in time, as well as to remind road maintenance personnel to repair and maintain the road surface in time.

An execution subject of the present disclosure may be any one of electronic devices, for example, a vehicle and a terminal device such as a vehicle-mounted terminal. The method for detecting a bumpy region of a road surface in the embodiments of the present disclosure will be described in detail below.

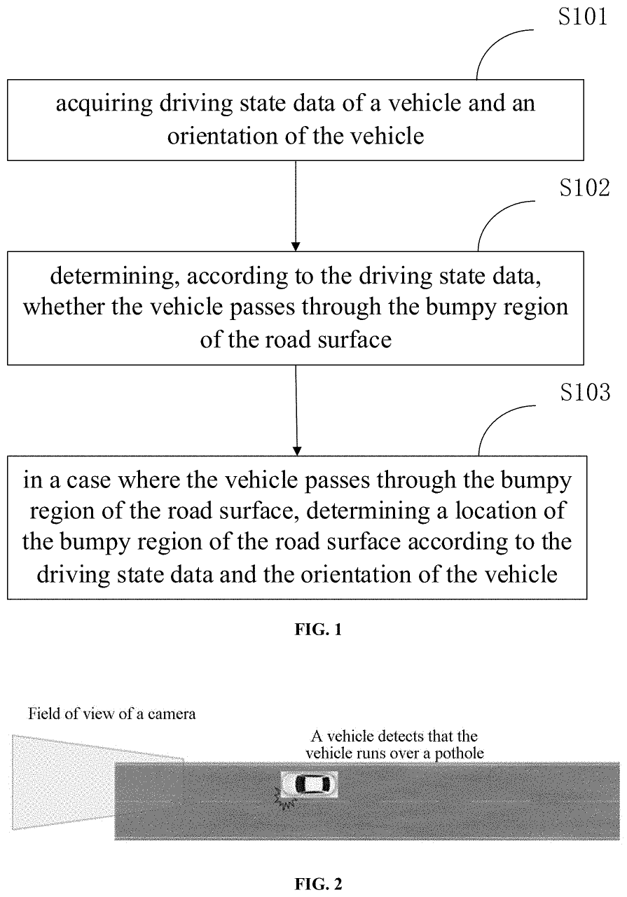

FIG. 1 is a schematic diagram of a method for detecting a bumpy region of a road surface according to an embodiment of the present disclosure. As shown in FIG. 1, the method for detecting a bumpy region of a road surface can include:

S101, acquiring driving state data of a vehicle and an orientation of the vehicle;

In a process that a vehicle drives on a road, the state data related to the driving of the vehicle can be acquired through a terminal device such as a vehicle-mounted terminal, and the state data includes but is not limited to a speed, an acceleration, an attitude angle, and a location of the vehicle. In addition, an orientation of the vehicle can also be obtained, namely, a direction corresponding to the front of the vehicle.

S102, determining, according to the driving state data, whether the vehicle passes through the bumpy region of the road surface; and

A state change of the vehicle during driving can be determined according to the driving state data, so as to determine whether the vehicle passes through the bumpy region of the road surface.

S103, in a case where the vehicle passes through the bumpy region of the road surface, determining a location of the bumpy region of the road surface according to the driving state data and the orientation of the vehicle.

According to the method for detecting a bumpy region of a road surface in the technical solution of the present disclosure, in a case where the vehicle passes through the bumpy region of the road surface, the location of the bumpy region of the road surface is determined by using the driving state data and the orientation of the vehicle, and the bumpy region of the road surface can be accurately located, thereby effectively reminding other vehicles to take measures in time and reminding road maintenance personnel to carry out road maintenance in time.

In a case where it is determined according to the driving state data of the vehicle that the vehicle is currently driving on the bumpy region of the road surface, a specific location of the bumpy region in a specific road section may be determined according to the driving state data of the vehicle and the direction corresponding to the front of the vehicle, so as to generate prompt information, which is sent to other vehicles or a terminal device of road maintenance personnel through a server, so that relevant personnel can know the situation of the bumpy region of the road surface and take corresponding measures in time.

Optionally, the vehicle-mounted terminal may also send the location of the bumpy region of the road surface to the server, and the server generates corresponding prompt information, which is displayed on an electronic map, or is converted into a voice prompt through a navigation system, so that other vehicles may know the location of the bumpy region of the road surface.

According to the method for detecting a bumpy region of a road surface in the embodiments of the present disclosure, in a case where the vehicle passes through the bumpy region of the road surface, the location of the bumpy region of the road surface is determined by using the driving state data and the orientation of the vehicle, and the bumpy region of the road surface can be accurately located, thereby effectively reminding other vehicles to take measures in time and reminding road maintenance personnel to carry out road maintenance in time.

In the technical solutions of the present disclosure, in addition to determining the location of the bumpy region of the road surface, other information related to the bumpy region of the road surface can also be obtained. Details are shown in the following embodiment.

In an implementation, the method further includes:

in a case where the vehicle passes through the bumpy region of the road surface, and the driving state data includes an acceleration, determining a depth or a height of the bumpy region of the road surface according to a component of the acceleration in a vertical direction.

In actual applications, in a case where the vehicle passes through the bumpy region of the road surface, the acceleration may change in the vertical direction compared with the vehicle driving on a flat road segment. Therefore, after the acceleration of the vehicle is acquired, a component in a z-axis direction of components of the acceleration in an x-axis direction, a y-axis direction, and a z-axis direction, i.e., the component in the vertical direction may be used to indicate a bump amplitude of the vehicle, so as to determine the depth of a recessed region or the height of a raised region of the road surface.

In the embodiments of the present disclosure, in addition to determining the location of the bumpy region of the road surface, the depth or the height of the bumpy region of the road surface can also be determined, so that other vehicles or road maintenance personnel can learn more information about the bumpy region of the road surface and facilitate to take corresponding measures, for example, slowing down or detouring to avoid the bumpy region of the road surface.

Herein, a specific implementation of determining the depth or the height of the bumpy region of the road surface according to the component of the acceleration in the vertical direction is shown in the following embodiment.

In an implementation, the determining the depth or the height of the bumpy region of the road surface according to the component of the acceleration in the vertical direction includes:

determining the depth or the height of the bumpy region of the road surface according to the component of the acceleration in the vertical direction and a first association relationship, wherein the first association relationship is a pre-established association relationship between the component of the acceleration in the vertical direction and the depth or the height of the bumpy region of the road surface.

Herein, the first association relationship may be a corresponding relationship table between the component of the acceleration in the vertical direction and the depth or the height of the bumpy region of the road surface. The corresponding relationship table between the component of the acceleration in the vertical direction and the depth or the height of the bumpy region of the road surface may be pre-established by means of calibration. For example, in a case where the vehicle separately presses through potholes of 1 cm, 2 cm, 3 cm, 4 cm, and 5 cm, components z₁, z₂, z₃, z₄, and z₅ of the acceleration of the vehicle in the vertical direction are separately recorded, so as to obtain a corresponding relationship table between the component in the vertical direction and the depth of the bumpy region of the road surface. Likewise, in a case where the vehicle separately presses through bulges of 1 cm, 2 cm, 3 cm, 4 cm, and 5 cm, components z₆, z₇, z₈, z₉, and z₁₀ of the acceleration of the vehicle in the vertical direction are separately recorded, so as to obtain a corresponding relationship table between the component in the vertical direction and the height of the bumpy region of the road surface.

Optionally, in pre-calibration, calibration may be performed separately based on different models and loads of vehicles. In this way, more accurate depth or height information of the bumpy region of the road surface can be obtained by applying the obtained corresponding relationship table to determine the height or the depth of the bumpy region of the road surface.

After the vehicle-mounted terminal acquires a real-time acceleration of the vehicle during driving, the depth or the height of the bumpy region of the road surface can be obtained through the component of the acceleration in the vertical direction and the pre-established corresponding relationship table.

In the embodiments of the present disclosure, the depth or the height of the bumpy region of the road surface is determined according to the component of the acceleration in the vertical direction and the pre-established association relationship between the component of the acceleration in the vertical direction and the depth or the height of the bumpy region of the road surface, so that the relatively accurate depth or height information of the bumpy region of the road surface can be obtained.

A specific implementation of the above S103 is shown in the following embodiment.

In an implementation, S103 includes:

S1031, in a case where the driving state data includes an attitude angle and a location of the vehicle, determining, according to the attitude angle, a wheel passing through the bumpy region of the road surface, of the vehicle; and

S1032, determining the location of the bumpy region of the road surface according to the wheel passing through the bumpy region of the road surface, of the vehicle, the location of the vehicle and the orientation of the vehicle.

In actual applications, in a case where different wheels of the vehicle (a front left wheel, a front right wheel, a rear left wheel, and a rear right wheel) pass through the bumpy region of the road surface, attitude angles of the vehicle are usually different. Therefore, the attitude angle of the vehicle may be used to determine which wheel or wheels of the vehicle passes/pass through the bumpy region of the road surface. The relative location of the wheel currently passing through the bumpy region of the road surface and the vehicle can be determined according to the wheel passing through the bumpy region of the road surface, of the vehicle and the orientation of the vehicle, and the location of the vehicle may be the location of a positioning device installed on the vehicle. The location of the wheel currently passing through the bumpy region of the road surface, i.e., the location of the bumpy region of the road surface may be obtained according to the relative location of the wheel currently passing through the bumpy region of the road surface and the vehicle, and the location of the vehicle.

In the embodiments of the present disclosure, the wheel passing through the bumpy region of the road surface, of the vehicle is first determined, and the location of the bumpy region of the road surface is determined according to the wheel passing through the bumpy region of the road surface, of the vehicle, the location of the vehicle, and the orientation of the vehicle, but the location of the bumpy region of the road surface is not determined only according to the location of the vehicle, so that the location of the bumpy region of the road surface determined in this way is more accurate.

Herein, a specific implementation of determining, according to the attitude angle, the wheel passing through the bumpy region of the road surface, of the vehicle is shown in the following embodiment.

In an implementation, S1031 includes:

determining the wheel passing through the bumpy region of the road surface, of the vehicle according to the attitude angle and a second association relationship, wherein the second association relationship is a pre-established association relationship between the attitude angle and the wheel passing through the bumpy region of the road surface, of the vehicle.

Herein, the second association relationship may be a corresponding relationship table between the attitude angle of the vertical and the wheel passing through the bumpy region of the road surface, of the vehicle. The corresponding relationship table between the attitude angle and the wheel passing through the bumpy region of the road surface, of the vehicle may be pre-established by means of calibration. For example, in a case where different wheels of the vehicle pass through a same recessed region of the road surface, attitude angles w₁, w₂, w₃, and w₄ of the vehicle are recorded separately. Likewise, in a case where different wheels of the vehicle pass through a same raised region of the road surface, attitude angles w₅, w₆, w₇, and w₈ of the vehicle are recorded separately, so as to obtain the corresponding relationship table between the attitude angle and the wheel passing through the bumpy region of the road surface, of the vehicle.

Optionally, in pre-calibration, calibration may be performed separately based on different models and loads of vehicles. In a case where determining the wheel passing through the bumpy region of the road surface through the corresponding relationship table obtained in this way, more accurate information can be obtained.

After the vehicle-mounted terminal acquires the real-time attitude angle of the vehicle during driving, the wheel passing through the bumpy region of the road surface can be determined through the attitude angle and the pre-established corresponding relationship table.

In the embodiments of the present disclosure, the wheel passing through the bumpy region of the road surface, of the vehicle is determined according to the attitude angle and the pre-established association relationship between the attitude angle and the wheel passing through the bumpy region of the road surface, of the vehicle, so that which wheel or wheels passes/pass through the bumpy region of the road surface can be determined relatively accurately, so as to facilitate subsequent determination of the location of the bumpy region of the road surface.

In the technical solutions of the present disclosure, in addition to the depth, the height, and the location of the bumpy region of the road surface, more information can be obtained. Details are shown in the following embodiment.

In an implementation, the method further includes:

collecting visualization information of a road surface in real time;

in a case where the driving state data includes a speed, acquiring a start moment during the vehicle passes through the bumpy region of the road surface;

determining an interval time based on a collection range and the speed;

determining a collection moment based on the start moment and the interval time;

using the visualization information collected at the collection moment as visualization information of the bumpy region of the road surface; and

determining an area of the bumpy region of the road surface based on the visualization information of the bumpy region of the road surface.

In actual applications, the vehicle-mounted terminal may collect the visualization information of the road surface in real time through a collection device installed on the vehicle. Generally, the vehicle passing through the bumpy region of the road surface and the visualization information of the bumpy region of the road surface being collected by the collection device are not synchronized in time, and there may be a time difference, namely, an interval time. The interval time may be determined according to the collection range of the collection device and the speed of the vehicle. In a case where a distance between the bumpy region of the road surface entering the collection range of the collection device and the vehicle passing through the bumpy region of the road surface remains unchanged, the faster the speed of the vehicle, the shorter the interval time. The start moment during the vehicle passes through the bumpy region of the road surface may be determined according to the change of the acceleration and the attitude angle of the vehicle. The collection moment at which the visualization information of the bumpy region of the road surface is collected by the collection device may be determined according to the start moment during the vehicle passes through the bumpy region of the road surface and the interval time, and the area of the bumpy region of the road surface may be determined according to the visualization information at this moment.

In the embodiments of the present disclosure, the area of the bumpy region of the road surface can be acquired, so that other vehicles and related personnel can know more information about the bumpy region of the road surface.

Herein, based on the start moment and the interval time, a specific implementation of determining the visualization information corresponding to the bumpy region of the road surface is shown in the following embodiment.

In an implementation, the determining the collection moment based on the start moment and the interval time includes:

in a case where a collection direction is same as the orientation of the vehicle, backtracking from the start moment by the interval time, to obtain the collection moment.

In actual applications, in a case where the orientation of the collection device is the same as the orientation of the vehicle, the collection device collects the visualization information of the bumpy region of the road surface first, and the vehicle passes through the bumpy region of the road surface later. It may be backtracked from the start moment at which the vehicle passes through the bumpy region of the road surface by the interval time to obtain a moment corresponding to the visualization information of the bumpy region of the road surface, namely, the collection moment. The visualization information collected by the collection device at the collection moment is searched, i.e., the visualization information of the bumpy region of the road surface.

In the embodiment of the present disclosure, in a case where the orientation of the collection device is the same as the orientation of the vehicle, the moment at which the visualization information of the bumpy region of the road surface is collected by the collection device is determined by way of backtracking, and the visualization information of the bumpy region of the road surface may be obtained according to this moment.

In an implementation, the determining the collection moment based on the start moment and the interval time includes:

in a case where a collection direction is opposite to the orientation of the vehicle, delaying from the start moment by the interval time, to obtain the collection moment.

In actual applications, in a case where the orientation of the collection device is opposite to the orientation of the vehicle, the vehicle passes through the bumpy region of the road surface first, and the collection device collects the visualization information of the bumpy region of the road surface later. It may be delayed from the start moment at which the vehicle passes through the bumpy region of the road surface by the interval time to obtain a moment corresponding to the visualization information of the bumpy region of the road surface, namely, the collection moment. The visualization information collected by the collection device at the collection moment is searched, i.e., the visualization information of the bumpy region of the road surface.

In the embodiment of the present disclosure, in a case where the orientation of the collection device is opposite to the orientation of the vehicle, the moment at which the visualization information of the bumpy region of the road surface is collected by the collection device is determined by way of delay, and the visualization information of the bumpy region of the road surface may be obtained according to this moment.

Herein, different types of collection devices may result in different collected visualization information. Details are shown in the following embodiment.

In an implementation, the visualization information is an image or point cloud data.

In actual applications, the collection device may be a camera. Optionally, the vehicle-mounted terminal may collect an image of the road surface through a camera of a driving recorder. In a case where the vehicle passes through the bumpy region of the road surface, the image of the bumpy region of the road surface is collected. The collection device may also be a laser radar. The vehicle-mounted terminal may collect point cloud data of the road surface through the laser radar installed on the top of the vehicle. In a case where the vehicle passes through the bumpy region of the road surface, the point cloud data of the bumpy region of the road surface is collected to obtain a three-dimensional model of the bumpy region of the road surface. The area of the bumpy region of the road surface may be calculated through the image or the point cloud data of the bumpy region of the road surface.

In the embodiments of the present disclosure, different types of visualization information of the bumpy region of the road surface may be collected by different types of collection devices, so as to meet different requirements.

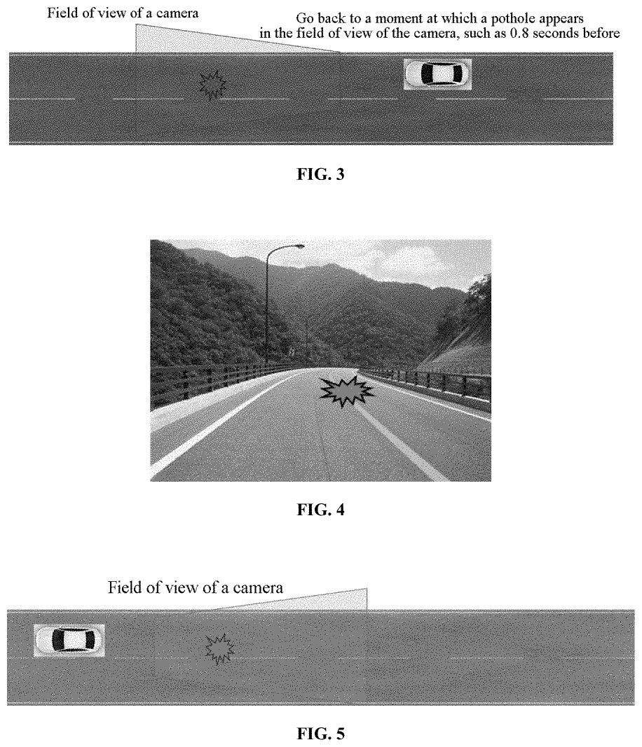

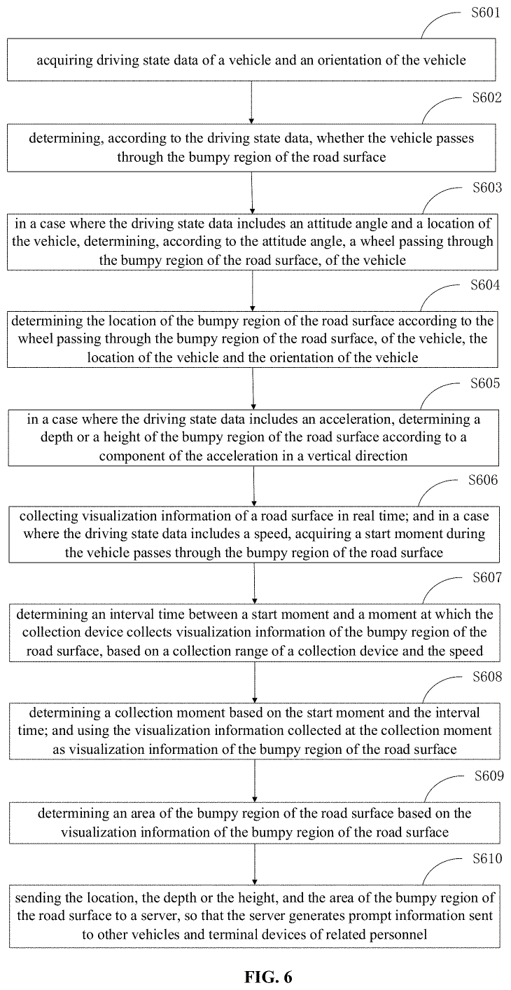

In a specific embodiment, the collection device is a camera, and the orientation of the camera is the same as the orientation of the vehicle. In a case where the vehicle is driving on the road, the vehicle-mounted terminal collects an image of the road surface through the camera in real time. As shown in FIG. 2, the vehicle-mounted terminal detects that the vehicle runs over a pothole, and at this time, the pothole is already outside the field of view of the camera. Therefore, it is necessary to go back 0.8 seconds from a moment at which the vehicle runs over the pothole, to a moment at which the pothole appears in the field of view of the camera, as shown in FIG. 3. The image at this moment is used as an image of a pothole region of the road surface, and the image shown in FIG. 4 is obtained. In a case where the orientation of the camera is opposite to the orientation of the vehicle, the vehicle runs over the pothole first, and then the image of the pothole appears in the field of view of the camera, as shown in FIG. 5. At this time, it is necessary to delay from the moment at which the vehicle runs over the pothole by 0.8 seconds, to obtain the image of the pothole region of the road surface.

In the embodiments of the present disclosure, for how to obtain the driving state data and the orientation of the vehicle, details are shown in the following embodiment.

In an implementation, S101 includes:

acquiring an acceleration and an attitude angle of the vehicle by using an inertial measurement unit;

acquiring the orientation of the vehicle and the location of the vehicle by using a RTK device; and

taking the acceleration, the attitude angle, and the location of the vehicle as running status data of the vehicle.

Herein, the driving state data of the vehicle may include the acceleration, the attitude angle, and the location of the vehicle. An inertial measurement unit (IMU) may be used to detect and measure the acceleration and a rotational motion, including an accelerometer and an angular velocity meter (also referred to as a gyroscope). Components of the acceleration of the vehicle in the x-axis direction, the y-axis direction, and the z-axis direction may be obtained through the accelerometer, and the attitude angle of the vehicle may be obtained through the angular velocity meter, herein, the attitude angle may include, but is not limited to, a pitch angle, a heading angle, and a roll angle. Optionally, a six-axis inertial measurement unit may be used to acquire the acceleration and the attitude angle of the vehicle.

A Real-Time Kinematic (RTK) device is a measurement device that can obtain a centimeter-level location accuracy in real time, and may acquire the orientation and the location of the vehicle. Optionally, a dual-antenna RTK device may be used to acquire the orientation and the location of the vehicle.

In the embodiments of the present disclosure, the acceleration and the attitude angle of the vehicle are obtained through the inertial measurement unit, and the orientation and the location of the vehicle are obtained through the RTK device. In this way, the obtained data are more accurate, and the information about the bumpy region determined based on these data is more accurate.

In an implementation, the determining, according to the driving state data, whether the vehicle passes through the bumpy region of the road surface includes:

determining, according to the component of the acceleration in the vertical direction and a preset threshold, whether the vehicle passes through the bumpy region of the road surface.

In actual applications, because the component of the acceleration of the vehicle in the vertical direction, i.e., the component in the z-axis direction, may indicate a degree of bumps of the vehicle, it may be determined, through the component of the acceleration in the vertical direction and the preset threshold, whether the vehicle passes through the bumpy region of the road surface. Herein, the preset threshold may be configured by those skilled in the art as required. For example, the preset threshold may be pre-configured according to different situations such as different models and different loads of vehicles.

Optionally, in addition to determining, according to the component of the acceleration in the vertical direction and the preset threshold, whether the vehicle passes through the bumpy region of the road surface, factors such as the attitude angle of the vehicle may also be combined to determine whether the vehicle passes through the bumpy region of the road surface. The present disclosure does not specifically limit this.

In the embodiments of the present disclosure, it is determined, according to the component of the acceleration in the vertical direction and the preset threshold, whether the vehicle passes through the bumpy region of the road surface. This is simple to implement, no additional device is needed, and the cost is low.

FIG. 6 is a schematic diagram of a method for detecting a bumpy region of a road surface according to an embodiment of the present disclosure. As shown in FIG. 6, the method for detecting a bumpy region of a road surface may include:

S601, acquiring driving state data of a vehicle and an orientation of the vehicle.

S602, determining, according to the driving state data, whether the vehicle passes through the bumpy region of the road surface.

S603, in a case where the driving state data includes an attitude angle and a location of the vehicle, determining, according to the attitude angle, a wheel passing through the bumpy region of the road surface, of the vehicle.

S604, determining the location of the bumpy region of the road surface according to the wheel passing through the bumpy region of the road surface, of the vehicle, the location of the vehicle and the orientation of the vehicle.

S605, in a case where the driving state data includes an acceleration, determining a depth or a height of the bumpy region of the road surface according to a component of the acceleration in a vertical direction.

S606, collecting visualization information of a road surface in real time, and in a case where the driving state data includes a speed, acquiring a start moment during the vehicle passes through the bumpy region of the road surface.

S607, determining an interval time between a start moment and a moment at which the collection device collects visualization information of the bumpy region of the road surface, based on a collection range of a collection device and the speed.

S608, determining a collection moment based on the start moment and the interval time, and using the visualization information collected at the collection moment as the visualization information of the bumpy region of the road surface.

S609, determining an area of the bumpy region of the road surface based on the visualization information of the bumpy region of the road surface.

S610, sending the location, the depth or the height, and the area of the bumpy region of the road surface to a server, so that the server generates prompt information sent to other vehicles and terminal devices of related personnel.

According to the method for detecting a bumpy region of a road surface in the technical solutions of the present disclosure, in a case where the vehicle passes through the bumpy region of the road surface, the location, the depth or the height, and the area of the bumpy region of the road surface are sent to the server, so that the server generates prompt information sent to other vehicles and terminal devices, thereby effectively reminding other vehicles to take measures in time and reminding road maintenance personnel to carry out road maintenance in time.

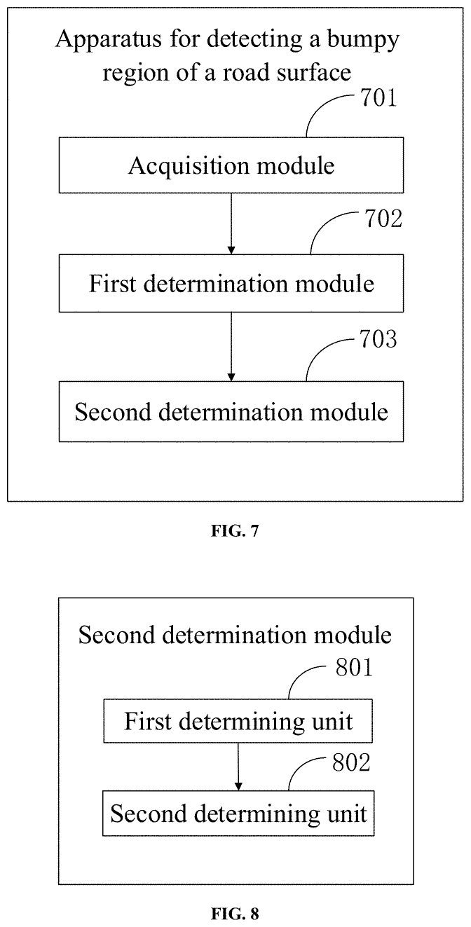

FIG. 7 is a schematic diagram of an apparatus for detecting a bumpy region of a road surface according to an embodiment of the present disclosure. As shown in FIG. 7, the apparatus for detecting a bumpy region of a road surface may include:

an acquisition module 701 configured for acquiring driving state data of a vehicle and an orientation of the vehicle;

a first determination module 702 configured for determining, according to the driving state data, whether the vehicle passes through the bumpy region of the road surface; and

a second determination module 703 configured for: in a case where the vehicle passes through the bumpy region of the road surface, determining a location of the bumpy region of the road surface according to the driving state data and the orientation of the vehicle.

According to the apparatus for detecting a bumpy region of a road surface in the technical solutions of the present disclosure, in a case where the vehicle passes through the bumpy region of the road surface, the location of the bumpy region of the road surface is determined by using the driving state data and the orientation of the vehicle, and the bumpy region of the road surface can be accurately located, thereby effectively reminding other vehicles to take measures in time and reminding road maintenance personnel to carry out road maintenance in time.

In an implementation, the apparatus further includes a third determination module, configured for:

in a case where the vehicle passes through the bumpy region of the road surface, and the driving state data includes an acceleration, determining a depth or a height of the bumpy region of the road surface according to a component of the acceleration in a vertical direction.

In an implementation, the third determination module is specifically configured for:

determining the depth or the height of the bumpy region of the road surface according to the component of the acceleration in the vertical direction and a first association relationship, where the first association relationship is a pre-established association relationship between the component of the acceleration in the vertical direction and the depth or the height of the bumpy region of the road surface.

FIG. 8 is a schematic diagram of a second determination module according to an embodiment of the present disclosure. As shown in FIG. 8, in an implementation, the second determination module 703 includes a first determining unit 801 and a second determining unit 802;

the first determining unit 801 is configured for: in a case where the driving state data includes an attitude angle and a location of the vehicle, determining, according to the attitude angle, a wheel passing through the bumpy region of the road surface, of the vehicle; and

the second determining unit 802 is configured for determining the location of the bumpy region of the road surface according to the wheel passing through the bumpy region of the road surface, of the vehicle, the location of the vehicle and the orientation of the vehicle.

In an implementation, the first determining unit 702 is specifically configured for:

determining the wheel passing through the bumpy region of the road surface, of the vehicle according to the attitude angle and a second association relationship, wherein the second association relationship is a pre-established association relationship between the attitude angle and the wheel passing through the bumpy region of the road surface, of the vehicle.

In an implementation, the apparatus further includes an area determination module, configured for:

collecting visualization information of a road surface in real time;

in a case where the driving state data includes a speed, acquiring a start moment during the vehicle passes through the bumpy region of the road surface;

determining an interval time based on a collection range and the speed;

determining a collection moment based on the start moment and the interval time;

using the visualization information collected at the collection moment as visualization information of the bumpy region of the road surface; and

determining an area of the bumpy region of the road surface based on the visualization information of the bumpy region of the road surface.

In an implementation, in a case of determining the collection moment based on the start moment and the interval time, the area determination module is configured for:

in a case where a collection direction is same as the orientation of the vehicle, backtracking from the start moment by the interval time, to obtain the collection moment.

In an implementation, in a case of determining the collection moment based on the start moment and the interval time, the area determination module is configured for:

in a case where a collection direction is opposite to the orientation of the vehicle, delaying from the start moment by the interval time, to obtain the collection moment.

In an implementation, the visualization information is an image or point cloud data.

In an implementation, the acquisition module 701 is specifically configured for:

acquiring an acceleration and an attitude angle of the vehicle by using an inertial measurement unit;

acquiring the orientation of the vehicle and the location of the vehicle by using a RTK device; and

taking the acceleration, the attitude angle, and the location of the vehicle as running status data of the vehicle.

In an implementation, the first determination module 702 is specifically configured for:

determining, according to the component of the acceleration in the vertical direction and a preset threshold, whether the vehicle passes through the bumpy region of the road surface.

For the function of each unit, module, or submodule in each apparatus according to the embodiments of the present disclosure, reference may be made to corresponding descriptions in the foregoing method embodiments, and details are not described herein again.

In the technical solutions of the present disclosure, acquisition, storage, and application of personal information of a user are in compliance with relevant laws and regulations, and does not violate public order and good customs.

According to embodiments of the present disclosure, the present disclosure also provides an electronic device, a readable storage medium and a computer program product.

According to an embodiment of the present disclosure, the present disclosure further provides a vehicle including at least one of the apparatus, the electronic device, or the non-transitory computer-readable storage medium of any embodiment of the present disclosure.

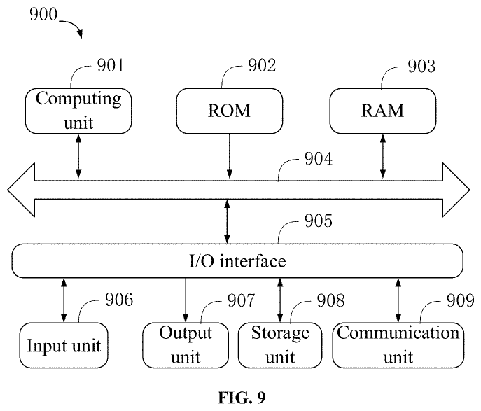

FIG. 9 shows a schematic block diagram of an example electronic device 900 that may be used to implement embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as a personal digital assistant, a cellular telephone, a smart phone, a wearable device, and other similar computing devices. The components shown herein, their connections and relationships, and their functions are by way of example only and are not intended to limit the implementations of the present disclosure described and/or claimed herein.

As shown in FIG. 9, the electronic device 900 includes a computing unit 901 that may perform various suitable actions and processes in accordance with computer programs stored in a read only memory (ROM) 902 or computer programs loaded from a storage unit 908 into a random access memory (RAM) 903. In the RAM 903, various programs and data required for the operation of the electronic device 900 may also be stored. The computing unit 901, the ROM 902 and the RAM 903 are connected to each other through a bus 904. An input/output (I/O) interface 905 is also connected to the bus 904.

A plurality of components in the electronic device 900 are connected to the I/O interface 905, including: an input unit 906, such as a keyboard, a mouse, etc.; an output unit 907, such as various types of displays, speakers, etc.; a storage unit 908, such as a magnetic disk, an optical disk, etc.; and a communication unit 909, such as a network card, a modem, a wireless communication transceiver, etc. The communication unit 909 allows the electronic device 900 to exchange information/data with other devices over a computer network, such as the Internet, and/or various telecommunications networks.

The computing unit 901 may be various general purpose and/or special purpose processing assemblies having processing and computing capabilities. Some examples of the computing unit 901 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 901 performs various methods and processes described above, such as the method for detecting a bumpy region of a road surface. For example, in some embodiments, the method for detecting a bumpy region of a road surface may be implemented as computer software programs that are physically contained in a machine-readable medium, such as the storage unit 908. In some embodiments, some or all of the computer programs may be loaded into and/or installed on the electronic device 900 via the ROM 902 and/or the communication unit 909. In a case where the computer programs are loaded into the RAM 903 and executed by the computing unit 901, one or more of steps of the above method for detecting a bumpy region of a road surface may be performed. Alternatively, in other embodiments, the computing unit 901 may be configured to perform the method for detecting a bumpy region of a road surface in any other suitable manner (e.g., by means of a firmware).

Various embodiments of the systems and techniques described herein above may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), a computer hardware, a firmware, a software, and/or a combination thereof. These various implementations may include an implementation in one or more computer programs, which can be executed and/or interpreted on a programmable system including at least one programmable processor; the programmable processor may be a dedicated or general-purpose programmable processor and capable of receiving and transmitting data and instructions from and to a storage system, at least one input device, and at least one output device.

The program codes for implementing the methods of the present disclosure may be written in any combination of one or more programming languages. These program codes may be provided to a processor or controller of a general purpose computer, a special purpose computer, or other programmable data processing apparatus such that the program codes, when executed by the processor or controller, enable the functions/operations specified in the flowchart and/or the block diagram to be performed. The program codes may be executed entirely on a machine, partly on a machine, partly on a machine as a stand-alone software package and partly on a remote machine, or entirely on a remote machine or server.

In the context of the present disclosure, the machine-readable medium may be a tangible medium that may contain or store programs for using by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include one or more wire-based electrical connection, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof.

In order to provide an interaction with a user, the system and technology described here may be implemented on a computer having: a display device (e. g., a cathode ray tube (CRT) or a liquid crystal display (LCD) monitor) for displaying information to the user; and a keyboard and a pointing device (e. g., a mouse or a trackball), through which the user can provide an input to the computer. Other kinds of devices can also provide an interaction with the user. For example, a feedback provided to the user may be any form of sensory feedback (e.g., visual feedback, auditory feedback, or tactile feedback); and an input from the user may be received in any form, including an acoustic input, a voice input or a tactile input.

The systems and techniques described herein may be implemented in a computing system (e.g., as a data server) that may include a background component, or a computing system (e.g., an application server) that may include a middleware component, or a computing system (e.g., a user computer having a graphical user interface or a web browser through which a user may interact with embodiments of the systems and techniques described herein) that may include a front-end component, or a computing system that may include any combination of such background components, middleware components, or front-end components. The components of the system may be connected to each other through a digital data communication in any form or medium (e.g., a communication network). Examples of the communication network may include a local area network (LAN), a wide area network (WAN), and the Internet.

The computer system may include a client and a server. The client and the server are typically remote from each other and typically interact via the communication network. The relationship of the client and the server is generated by computer programs running on respective computers and having a client-server relationship with each other. The server may be a cloud server, and may also be a server of a distributed system, or a server incorporating a blockchain.

It should be understood that the steps can be reordered, added or deleted using the various flows illustrated above. For example, the steps described in the present disclosure may be performed concurrently, sequentially or in a different order, so long as the desired results of the technical solutions disclosed in the present disclosure can be achieved, and there is no limitation herein.

The above-described specific embodiments do not limit the scope of the present disclosure. It will be apparent to those skilled in the art that various modifications, combinations, sub-combinations and substitutions are possible, depending on design requirements and other factors. Any modifications, equivalent substitutions, and improvements within the spirit and principles of the present disclosure are intended to be included within the scope of the present disclosure.

1. A method for detecting a bumpy region of a road surface, comprising:
acquiring driving state data of a vehicle and an orientation of the vehicle;
determining, according to the driving state data, whether the vehicle passes through the bumpy region of the road surface; and
in a case where the vehicle passes through the bumpy region of the road surface, determining a location of the bumpy region of the road surface according to the driving state data and the orientation of the vehicle.

2. The method of claim 1, further comprising:
in a case where the vehicle passes through the bumpy region of the road surface, and the driving state data comprises an acceleration, determining a depth or a height of the bumpy region of the road surface according to a component of the acceleration in a vertical direction.

3. The method of claim 2, wherein the determining the depth or the height of the bumpy region of the road surface according to the component of the acceleration in the vertical direction, comprises:
determining the depth or the height of the bumpy region of the road surface according to the component of the acceleration in the vertical direction and a first association relationship, wherein the first association relationship is a pre-established association relationship between the component of the acceleration in the vertical direction and the depth or the height of the bumpy region of the road surface.

4. The method of claim 1, wherein the determining the location of the bumpy region of the road surface according to the driving state data and the orientation of the vehicle, comprises:
in a case where the driving state data comprises an attitude angle and a location of the vehicle, determining, according to the attitude angle, a wheel passing through the bumpy region of the road surface, of the vehicle; and
determining the location of the bumpy region of the road surface according to the wheel passing through the bumpy region of the road surface, of the vehicle, the location of the vehicle and the orientation of the vehicle.

5. The method of claim 4, wherein the determining, according to the attitude angle, the wheel passing through the bumpy region of the road surface, of the vehicle, comprises:
determining the wheel passing through the bumpy region of the road surface, of the vehicle according to the attitude angle and a second association relationship, wherein the second association relationship is a pre-established association relationship between the attitude angle and the wheel passing through the bumpy region of the road surface, of the vehicle.

6. The method of claim 1, further comprising:
collecting visualization information of a road surface in real time;
in a case where the driving state data comprises a speed, acquiring a start moment during the vehicle passes through the bumpy region of the road surface;
determining an interval time based on a collection range and the speed;
determining a collection moment based on the start moment and the interval time;
using the visualization information collected at the collection moment as visualization information of the bumpy region of the road surface; and
determining an area of the bumpy region of the road surface based on the visualization information of the bumpy region of the road surface.

7. The method of claim 6, wherein the determining the collection moment based on the start moment and the interval time, comprises:
in a case where a collection direction is same as the orientation of the vehicle, backtracking from the start moment by the interval time, to obtain the collection moment; or in a case where a collection direction is opposite to the orientation of the vehicle, delaying from the start moment by the interval time, to obtain the collection moment, and
wherein the visualization information is an image or point cloud data.

8. The method of claim 1, wherein the acquiring the driving state data of the vehicle and the orientation of the vehicle, comprises:
acquiring an acceleration and an attitude angle of the vehicle by using an inertial measurement unit;
acquiring the orientation of the vehicle and the location of the vehicle by using a Real-Time Kinematic RTK device; and
taking the acceleration, the attitude angle, and the location of the vehicle as running status data of the vehicle.

9. The method of claim 2, wherein the determining, according to the driving state data, whether the vehicle passes through the bumpy region of the road surface, comprises:
determining, according to the component of the acceleration in the vertical direction and a preset threshold, whether the vehicle passes through the bumpy region of the road surface.

10. An electronic device, comprising:
at least one processor; and
a memory communicatively connected with the at least one processor,
wherein the memory stores instructions executable by the at least one processor, and the instructions, when executed by the at least one processor, enable the at least one processor to perform operations of:
acquiring driving state data of a vehicle and an orientation of the vehicle;
determining, according to the driving state data, whether the vehicle passes through the bumpy region of the road surface; and
in a case where the vehicle passes through the bumpy region of the road surface, determining a location of the bumpy region of the road surface according to the driving state data and the orientation of the vehicle.

11. The electronic device of claim 10, wherein the instructions, when executed by the at least one processor, enable the at least one processor to further perform an operation of:
in a case where the vehicle passes through the bumpy region of the road surface, and the driving state data comprises an acceleration, determining a depth or a height of the bumpy region of the road surface according to a component of the acceleration in a vertical direction.

12. The electronic device of claim 11, wherein the determining the depth or the height of the bumpy region of the road surface according to the component of the acceleration in the vertical direction, comprises:
determining the depth or the height of the bumpy region of the road surface according to the component of the acceleration in the vertical direction and a first association relationship, wherein the first association relationship is a pre-established association relationship between the component of the acceleration in the vertical direction and the depth or the height of the bumpy region of the road surface.

13. The electronic device of claim 10, wherein the determining the location of the bumpy region of the road surface according to the driving state data and the orientation of the vehicle, comprises:
in a case where the driving state data comprises an attitude angle and a location of the vehicle, determining, according to the attitude angle, a wheel passing through the bumpy region of the road surface, of the vehicle; and
determining the location of the bumpy region of the road surface according to the wheel passing through the bumpy region of the road surface, of the vehicle, the location of the vehicle and the orientation of the vehicle.

14. The electronic device of claim 13, wherein the determining, according to the attitude angle, the wheel passing through the bumpy region of the road surface, of the vehicle, comprises:
determining the wheel passing through the bumpy region of the road surface, of the vehicle according to the attitude angle and a second association relationship, wherein the second association relationship is a pre-established association relationship between the attitude angle and the wheel passing through the bumpy region of the road surface, of the vehicle.

15. The electronic device of claim 10, wherein the instructions, when executed by the at least one processor, enable the at least one processor to further perform operations of:
collecting visualization information of a road surface in real time;
in a case where the driving state data comprises a speed, acquiring a start moment during the vehicle passes through the bumpy region of the road surface;
determining an interval time based on a collection range and the speed;
determining a collection moment based on the start moment and the interval time;
using the visualization information collected at the collection moment as visualization information of the bumpy region of the road surface; and
determining an area of the bumpy region of the road surface based on the visualization information of the bumpy region of the road surface.

16. The electronic device of claim 15, wherein the determining the collection moment based on the start moment and the interval time, comprises:
in a case where a collection direction is same as the orientation of the vehicle, backtracking from the start moment by the interval time, to obtain the collection moment; or in a case where a collection direction is opposite to the orientation of the vehicle, delaying from the start moment by the interval time, to obtain the collection moment, and
wherein the visualization information is an image or point cloud data.

17. The electronic device of claim 10, wherein the acquiring the driving state data of the vehicle and the orientation of the vehicle, comprises:
acquiring an acceleration and an attitude angle of the vehicle by using an inertial measurement unit;
acquiring the orientation of the vehicle and the location of the vehicle by using a Real-Time Kinematic RTK device; and
taking the acceleration, the attitude angle, and the location of the vehicle as running status data of the vehicle.

18. The electronic device of claim 11, wherein the determining, according to the driving state data, whether the vehicle passes through the bumpy region of the road surface, comprises:
determining, according to the component of the acceleration in the vertical direction and a preset threshold, whether the vehicle passes through the bumpy region of the road surface.

19. A non-transitory computer-readable storage medium storing computer instructions, wherein the computer instructions, when executed by a computer, cause the computer to perform operations of:
acquiring driving state data of a vehicle and an orientation of the vehicle;
determining, according to the driving state data, whether the vehicle passes through the bumpy region of the road surface; and
in a case where the vehicle passes through the bumpy region of the road surface, determining a location of the bumpy region of the road surface according to the driving state data and the orientation of the vehicle.

20. A vehicle, comprising the electronic device of claim 10.

21. A vehicle, comprising the non-transitory computer-readable storage medium of claim 19.
